(19) United States
(12) Patent Application Publication
(10) Pub. No.: US 2006/0015536 A1
(43) Pub. Date: Jan. 19, 2006

(54) Database and method of use for authenticity verification of pharmaceuticals

(76) Inventors: Bruce R. Buchanan, Elkton, VA (US); Eric W. Richmond, Shenandoah, VA (US); Glen Wollenberg, Massanutten, VA (US)

Correspondence Address: FULBRIGHT & JAWORSKI, LLP, 1301 MCKINNEY, SUITE 5100, HOUSTON, TX, 77010-3095, US

(21) Appl. No.: 10/775,278

(22) Filed: Feb. 10, 2004

Related U.S. Application Data
(60) Provisional application No. 60/446,415, filed on Feb. 10, 2003.

(51) Int. Cl. G06F 12/00

(52) U.S. Cl. 707/200

(57) ABSTRACT

The present invention relates to the development and use of a global database system for the authentication of pharmaceutical material, the detection of counterfeit pharmaceutical material and the detection of medication errors. The database is not limited to any particular species of data. A central facility maintains the global library and communicates with users of the database.

### CROSS-REFERENCE TO RELATED APPLICATIONS

This application claims priority to U.S. Provisional Application Ser. No. 60/446,415, filed on Feb. 10, 2003.

### TECHNICAL FIELD

The present invention relates to the development and use of a global information database, centrally maintained, to enable the remote analysis of finished pharmaceutical product generally, and specifically for the positive verification (i.e., authentication) of genuine finished dosage pharmaceutical product at points along the pharmaceutical supply chain.

### BACKGROUND OF THE INVENTION

Authenticating the identity of pharmaceutical products is essential for various reasons. Such methods have been used historically, and continue to be used as basic quality control and standard compendial tests. Recently, tests for the positive verification (i.e., authentication) of pharmaceutical products have taken on a heightened importance as counterfeiting and importation or re-importation of pharmaceutical products and errors in dispensing of pharmaceutical products in hospitals and pharmacies raise serious health and safety issues.

One way to staunch the flow of counterfeit pharmaceutical products would entail repetitive testing for authenticity from point of manufacture to point of dispensing or administration at multiple points along the pharmaceutical supply chain. This is presently not feasible due to cost, or to preclusive time and testing constraints and due to the lack of a database of uniquely identifiable information about authentic drug products. If the industry had universal, trouble-free access to a centrally maintained and managed, secure database of uniquely identifiable information, enabling the use of rapid, non-destructive remote tests for authenticity, there would be increased likelihood that counterfeit products would be interdicted at some point in the supply chain. These points include, but are not limited to, pharmaceutical manufacturers, drug distribution centers, drug repackaging facilities, ports-of-entry, customs facilities, import facilities, mail facilities, regulatory centers (whether or not they are run by the government), government centers (such as law enforcement centers but also including government regulatory centers) pharmacies, hospitals, dispensaries, clinics, assisted-living facilities, etc. Early detection of counterfeit pharmaceuticals would facilitate law enforcement efforts in this area and simultaneously minimize the negative impact of counterfeit products on the pharmaceutical and related industries, on the pharmaceutical distribution network, and on the health and safety of the pharmaceutical consumer. Currently, the integrity of the pharmaceutical supply chain is dominated by paper pedigrees; that is accompanying documentation designed to provide proof of authenticity. However, reliance on these methods is susceptible to counterfeiting and fraud.

Errors associated with the dispensing or administering of drug products to patients occur at every stage in the medication administration process—prescribing, dispensing and administration. A significant portion of these medication errors involves the wrong drug and/or the wrong dose being provided to the patient. One way to reduce medication errors would entail repetitive testing for authenticity at multiple points in medication administration chain. This is presently not feasible due to cost, or to preclusive time and testing constraints and due to the lack of a database of information and a uniform data standard of uniquely identifiable information about authentic drug products. If the industry had universal, unrestricted, and trouble-free access to a database of uniquely identifiable information, enabling the use of rapid, non-destructive remote tests for authenticity, there would be increased likelihood that incorrect products would be interdicted at some point in the medication administration process. These points include, but are not limited to, pharmacies, hospitals, dispensaries, clinics, assisted-living facilities, etc. Eliminating medication errors will reduce adverse drug events and death, and generally improve patient safety and healthcare quality leading to increased confidence in the healthcare system and significant economic benefit.

There exists a need for comprehensive analytical monitoring in portable and remote settings to identify counterfeit pharmaceutical products and/or to eliminate medication errors. Current systems generally suffer in this type of application in that they provide only limited, special-purpose capabilities. More specifically, existing systems do not support large analytical data libraries supporting a wide variety of analytical data (e.g., product information including, but not limited to, images of products, packaging and labeling information and forensic information including, but not limited to, chemical and physical properties or characteristics of pharmaceutical materials and packaging) from multiple manufacturers or suppliers for the vast number of commercially available pharmaceutical products subject to counterfeiting or at high-risk to medication errors.

At the same time, in the computer industry there has been a movement toward system interoperability through open systems protocols. This movement is being driven by new applications level protocols and file formats. These protocols and file format standards have allowed interoperability between computers using different operating systems, hardware platforms, and applications suites. Within the government and industry these data transfer protocols, mostly oriented towards transmission and/or sharing of images and documents, have substantially improved the usefulness of remote computer-based systems. Applying these infrastructures to the problem of remote authenticity testing for counterfeit pharmaceutical products or eliminating medication errors is needed owing to the data-intensive nature of the problem.

Previous attempts at tackling the remote analysis problem have involved various forms of automation coupled with remote non-destructive identification analyses. These methods most often utilize a library containing only one type of uniquely identifiable information, for example, forensic information and require a previously developed and validated library of pharmaceutical manufacturer verified genuine product. However, the availability, development and maintenance of central libraries sufficient to support the enormous number of finished pharmaceutical products currently on the market is presently lacking. Furthermore, what is desired is an automated way of providing to the remote testing site, a plurality of uniquely identifiable information in a rapid, efficient, and accurate fashion. The remote testing site is thus freed of the requirement of development and maintenance of the database and merely becomes a subscriber to it. Such an automated system should be modular to allow expansion for new types of analytical data. This allows maximum flexibility to the remote testing site.

It is important to develop rapid, cost effective, and enforceable methods to identify fraudulent or tampered products. It is also important to determine manufacturing compliance using automated methods to decrease the amount of time spent identifying fraudulent products. It is desirable to minimize the time required from highly skilled researchers and technicians to conduct and record the results of on-line, off-line, and off-the-shelf product authenticity/compliance tests.

It is important to develop rapid, cost effective methods to confirm medication administration accuracy. It is also important to automate methods to decrease the amount of time required from highly skilled nurses, doctors and pharmacists to conduct and record the results of authenticity/compliance tests.

### SUMMARY OF THE INVENTION

The present invention is directed to a database system comprising a global library of analytical data for the remote analysis of pharmaceutical material. The present invention is also directed to a method of use of a database system comprising a global library of analytical data for the remote analysis of finished pharmaceutical dosage forms. The present invention also encompasses methods and databases to identify counterfeit pharmaceutical materials. The present invention also encompasses methods and databases to identify medication errors and to confirm medication administration accuracy.

In the present invention, there is a centrally maintained and managed information database system comprising data comprising at least one library of uniquely identifiable information for finished pharmaceutical dosage forms, the at least one library having uniquely identifiable information for finished pharmaceutical dosage forms manufactured by more than one manufacturer; a central facility to house the data and to receive and/or transfer information to or from at least one user; and, a communication link between the central facility and the user. In some embodiments, the information database system further comprises at least one satellite instrument at a local testing center remote from said central facility. In some embodiments, the local testing center is located at a site in the supply chain of said pharmaceutical material. Some non-limiting examples of said site include pharmaceutical manufacturers, drug distribution centers, drug repackaging facilities, ports-of-entry, customs facilities, import facilities, mail facilities, government centers, regulatory centers, pharmacies, hospitals, dispensaries, clinics, assisted-living facilities, and any combination thereof. In preferred embodiments, the at least one library comprises data collected from forensic methods selected from the group consisting of near-infrared spectroscopy, infrared spectroscopy, UV-VIS spectroscopy, fluorescence spectroscopy, phosphorescence spectroscopy, Raman spectroscopy, microwave spectroscopy, photo-acoustic spectroscopy, X-ray spectroscopy, chemical imaging, and any combination thereof. In some embodiments, the at least one library comprises data selected from the group consisting of images of products, packaging attributes, labeling attributes, product codes, lot numbers, expiration dates, track and trace data, and any combination thereof. Preferably, the communication link comprises an internet link. In some embodiments, the database system further comprises a library of analytical information of known counterfeit finished pharmaceutical dosage forms. In some embodiments, the pharmaceutical material comprises a finished pharmaceutical dosage form selected from the group consisting of oral dosage forms, injectables, inhalants, intravenous solutions, transdermals, suppositories, ophthalmics, and combinations thereof. In preferred embodiments, the at least one library is a validated library. In preferred embodiments, the at least one library is an updated library. In preferred embodiments, the database system is a global database system. In preferred embodiments, the information database is maintained and managed by an entity distinct from said at least one user. In some embodiments, the data comprising at least one library comprises a plurality of libraries. In some embodiments, the central facility transfers data to said at least one user.

In another embodiment of the present invention, there is a centrally maintained and managed information database system comprising data comprising at least one library of uniquely identifiable information for pharmaceutical material selected from the group consisting of active pharmaceutical ingredients, excipients, pharmaceutical raw materials, pharmaceutical packaging materials, and combinations thereof, the pharmaceutical material manufactured by more than one manufacturer; a central facility to house said data and to receive and/or transfer information to or from at least one user; and, a communication link between the central facility and the user. In preferred embodiments, the at least one library comprises data collected from forensic methods selected from the group consisting of near-infrared spectroscopy, infrared spectroscopy, UV-VIS spectroscopy, fluorescence spectroscopy, phosphorescence spectroscopy, Raman spectroscopy, microwave spectroscopy, photo-acoustic spectroscopy, X-ray spectroscopy, chemical imaging, and any combination thereof. In some embodiments, the at least one library comprises data selected from the group consisting of images of products, packaging attributes, labeling attributes, product codes, lot number, expiration dates, track and trace data, and any combination thereof. In some embodiments, the information database system further comprises at least one satellite instrument at a local testing center remote from said central facility wherein said local testing center is located at a site in the supply chain of said pharmaceutical material. Some non-limiting examples of the site include pharmaceutical manufacturers, drug distribution centers, drug repackaging facilities, ports-of-entry entry, customs facilities, import facilities, mail facilities, government centers, regulatory centers, pharmacies, hospitals, dispensaries, clinics, assisted-living facilities, and any combination thereof. In preferred embodiments, the at least one library is a validated library. In preferred embodiments, the at least one library is an updated library. In preferred embodiments, the database system is a global database system. In preferred embodiments, the database is maintained and managed by an entity distinct from said at least one user. In some embodiments, the data comprising at least one library comprises a plurality of libraries. In some embodiments, the central facility transfers data to said at least one user.

In another embodiment of the present invention, there is a method for the determination of authenticity of a sample of pharmaceutical material comprising collecting data for the sample of pharmaceutical material at a remote location; transmitting information to or receiving information from, a central facility having a database comprising data, the data comprising at least one library of uniquely identifiable information for authentic pharmaceutical material corresponding to the sample, the database comprising data for pharmaceutical material manufactured by multiple manufacturers; and, comparing the data for said sample of pharmaceutical material to the data comprising at least one library. In some embodiments, the method further comprises the step of processing said data for said sample of pharmaceutical material. In a preferred embodiment, the at least one library is constructed from manufacturer-verified pharmaceutical material. In some embodiments, the method further comprises the step of supplementing the library with the analytical data collected for said sample at said remote location. In some embodiments, the method further comprises the step of collecting assay data relating to said sample. In some embodiments, the sample comprises a pharmaceutical ingredient. Non-limiting examples of the pharmaceutical ingredient include active pharmaceutical ingredients, excipients, pharmaceutical raw materials, pharmaceutical mixtures, pharmaceutical packaging materials, and combinations thereof. In some embodiments, the pharmaceutical ingredient is a pharmaceutical mixture. The pharmaceutical mixture may, for example, be a granulation. In preferred embodiments, the data comprising at least one library comprises data collected from forensic methods selected from the group consisting of near-infrared spectroscopy, infrared spectroscopy, UV-VIS spectroscopy, fluorescence spectroscopy, phosphorescence spectroscopy, Raman spectroscopy, microwave spectroscopy, photo-acoustic spectroscopy, X-ray spectroscopy, chemical imaging, and any combination thereof. In some embodiments, the data comprising at least one library comprises data selected from the group consisting images of products, packaging attributes, labeling attributes, product codes, lot numbers, expiration dates track and trace data, and any combination thereof. In preferred embodiments, the at least one library is a validated library. In preferred embodiments, the at least one library is an updated library. In preferred embodiments, the database is a global database. In preferred embodiments, the database is maintained and managed by an entity other than that performing the step of collecting.

In another embodiment of the present invention, there is a method for the determination of authenticity of a sample of finished pharmaceutical dosage form comprising collecting data for said sample of finished pharmaceutical dosage form at a remote location; transmitting information to or receiving information from, a central facility having a database comprising data, the data comprising at least one library of uniquely identifiable information for authentic finished pharmaceutical dosage form corresponding to the sample, the database comprising data for finished pharmaceutical dosage forms manufactured by multiple manufacturers; and, comparing the data for the sample to the data comprising at least one library. In preferred embodiments, the finished pharmaceutical dosage form is selected from the group consisting of oral dosage forms, injectables, inhalants, intravenous solutions, transdermals, suppositories, ophthalmics, and combinations thereof. In some embodiments, the method further comprises the step of processing said data for said finished pharmaceutical dosage form. In preferred embodiments, the at least one library is constructed from manufacturer-verified pharmaceutical material. In some embodiments, the method further comprises the step of supplementing the library with the analytical data collected for the sample at said remote location. In some embodiments, the method further comprises the step of collecting assay data relating to said sample. In preferred embodiments, the data comprising at least one library comprises data collected from forensic methods selected from the group consisting of near-infrared spectroscopy, infrared spectroscopy, UV-VIS spectroscopy, fluorescence spectroscopy, phosphorescence spectroscopy, Raman spectroscopy, microwave spectroscopy, photo-acoustic spectroscopy, X-ray spectroscopy, chemical imaging, and any combination thereof. In some embodiments, the data comprising at least one library comprises data selected from the group consisting of images of products, packaging attributes, labeling attributes, product codes, lot number, expiration dates track and trace data, and any combination thereof. In preferred embodiments, the at least one library is a validated library. In preferred embodiments, the at least one library is an updated library. In preferred embodiments, the database is a global database. In preferred embodiments, the database is maintained and managed by an entity other than that performing the step of collecting.

In another embodiment of the present invention, there is a method for the determination of authenticity of a sample of pharmaceutical material comprising collecting data for the sample of pharmaceutical material at a remote location; transmitting to said remote location from a database at a central facility, data comprising at least one library of uniquely identifiable information for authentic pharmaceutical material corresponding to the sample, the database comprising data for pharmaceutical material manufactured by multiple manufacturers; and, comparing, at the remote location, the data for the sample of pharmaceutical material to the data comprising at least one library. In preferred embodiments, the database is maintained and managed by an entity other than that performing the step of collecting.

In another embodiment of the present invention, there is a method for the determination of authenticity of a sample of finished pharmaceutical dosage form comprising collecting data for the sample of finished pharmaceutical dosage form at a remote location; transmitting to the remote location from a database at a central facility, data comprising at least one library of uniquely identifiable information for authentic finished pharmaceutical dosage form corresponding to the sample, the database comprising data for finished pharmaceutical dosage forms manufactured by multiple manufacturers; and, comparing, at the remote location, the data for said sample to the data comprising at least one library. In preferred embodiments, the database is maintained and managed by an entity other than that performing the step of collecting.

In another embodiment of the present invention, there is a method for the determination of authenticity of a sample of a finished pharmaceutical dosage form comprising collecting data for the finished pharmaceutical dosage form at a remote location; transmitting information to or receiving information from, a central facility having a database comprising data, the data comprising at least one library of uniquely identifiable information for authentic finished pharmaceutical dosage form corresponding to the sample; and, comparing the data for the finished pharmaceutical dosage form to the data comprising at least one library.

In another embodiment of the present invention, there is a pharmaceutical authenticity verification system comprising a centrally maintained and managed database having data comprising at least one library of uniquely identifiable information for pharmaceutical material, a remote instrument, the remote instrument collects data for a pharmaceutical sample and is in communication with the database. In preferred embodiments, the database is maintained and managed by an entity other than the entity that collects said data for a pharmaceutical sample.

In another embodiment of the present invention, there is a computer-implemented method of verifying authenticity of a pharmaceutical sample, the method comprising providing a centrally maintained and managed database comprising data of at least one library of uniquely identifiable information for authentic pharmaceutical material; comparing data collected from a pharmaceutical sample; and, determining whether the pharmaceutical sample is authentic.

In another embodiment of the present invention, there is a product comprising a computer program on a computer readable memory executable by a computer, the program comprising instructions for receiving data for a pharmaceutical material, instructions for comparing the data for a pharmaceutical material to data in a centrally maintained and managed pharmaceutical information database, and instructions for determining whether the pharmaceutical material is authentic or counterfeit.

In another embodiment of the present invention, there is a centrally maintained and managed information database system comprising data comprising at least one library of spectroscopic information for finished pharmaceutical dosage forms, the dosage forms being manufactured by multiple manufacturers; a central facility to house said library and to transfer information from the central facility to at least one user; and, a communication link between the central facility and the user. In preferred embodiments, the at least one library of spectroscopic information comprises Near-IR data, Raman data, chemical imaging data, and any combination thereof. In preferred embodiments, the database is maintained and managed by an entity other than said user.

In another embodiment of the present invention, there is a method to identify a counterfeit sample of pharmaceutical material comprising collecting data for a sample of pharmaceutical material at a remote location; transmitting information to or receiving information from, a central facility, the central facility having a database comprising at least one library of uniquely identifiable information for pharmaceutical material, said uniquely identifiable information comprising data for pharmaceutical material manufactured by multiple manufacturers; and, comparing the data for the sample to the at least one library. In some embodiments, the pharmaceutical material comprises a pharmaceutical ingredient selected from the group consisting of active pharmaceutical ingredients, excipients, pharmaceutical raw materials, pharmaceutical mixtures, pharmaceutical packaging materials, and any combination thereof. In preferred embodiments, the pharmaceutical material is a finished pharmaceutical dosage form selected from the group of consisting of oral dosage forms, injectables, inhalants, intravenous solutions, transdermals, suppositories, ophthalmics, and any combination thereof. In some embodiments, the database comprising at least one library comprises data for counterfeit pharmaceutical material. In some embodiments, the method further comprises the step of correlating said data for said pharmaceutical sample to complimentary data for said sample. In some embodiments, the method further comprises the step of processing said data for said sample. In preferred embodiments, the at least one library is constructed from manufacturer-verified pharmaceutical material. In some embodiments, the method further comprises the step of supplementing the at least one library with data collected for the sample at said remote location. Some non-limiting examples of remote locations are sites selected from the group consisting of pharmaceutical manufacturers, drug distribution centers, drug repackaging facilities, ports-of-entry, customs facilities, import facilities, mail facilities, government centers, regulatory centers, pharmacies, hospitals, dispensaries, clinics, assisted-living facilities, and any combination thereof. In some embodiments, the method further comprises the step of collecting assay data for said sample of pharmaceutical material. In preferred embodiments, the database comprises at least one library comprises data collected from forensic methods selected from the group consisting of near-infrared spectroscopy, infrared spectroscopy, UV-VIS spectroscopy, fluorescence spectroscopy, phosphorescence spectroscopy, Raman spectroscopy, microwave spectroscopy, photo-acoustic spectroscopy, X-ray spectroscopy, chemical imaging, and any combination thereof. In some embodiments, the database comprising at least one library comprises data selected from the group consisting of images of products, packaging attributes, labeling attributes, product codes, lot number, expiration dates track and trace data, and any combination thereof. In preferred embodiments, the at least one library is a validated library. In preferred embodiments, the at least one library is an updated library. In preferred embodiments, the database is a global database. In some embodiments, the database comprising at least one library comprises a plurality of libraries. In preferred embodiments, the database is maintained and managed by an entity other than that performing the step of collecting data.

In another embodiment of the present invention, there is a method to detect a medication error comprising collecting data for a sample of finished pharmaceutical dosage form at a remote location; transmitting information to or receiving information from, a central facility, the central facility having a database comprising at least one library of uniquely identifiable information comprising data for finished pharmaceutical dosage forms, and, comparing the data for the sample to the at least one library. In preferred embodiments, the finished pharmaceutical dosage form is selected from the group consisting of oral dosage forms, injectables, inhalants, intravenous solutions, transdermals, suppositories, ophthalmics, and any combination thereof. In some embodiments, the least one library of uniquely identifiable information comprises data for counterfeit finished pharmaceutical dosage forms. In some embodiments, the method further comprises the step of correlating the data for the pharmaceutical sample to complimentary data for the sample. In some embodiments, the method further comprises the step of processing said data for said finished pharmaceutical dosage form. In preferred embodiments, the at least one library is constructed from manufacturer-verified. pharmaceutical material. In some embodiments, the method further comprises the step of supplementing the library with the analytical data collected for the sample at said remote location. In preferred embodiments, the remote location is a site selected from the group consisting of pharmacies, hospitals, dispensaries, clinics, assisted-living facilities, and any combination thereof. In some embodiments, the method further comprises the step of collecting assay data for said sample of finished pharmaceutical dosage form. In preferred embodiments, the at least one library comprises data collected from forensic methods selected from the group consisting of near-infrared spectroscopy, infrared spectroscopy, UV-VIS spectroscopy, fluorescence spectroscopy, phosphorescence spectroscopy, Raman spectroscopy, microwave spectroscopy, photo-acoustic spectroscopy, X-ray spectroscopy, chemical imaging, and any combination thereof. In some embodiments, the at least one library comprises data selected from the group consisting of images of products, packaging attributes, labeling attributes, product codes, lot number, expiration dates, track and trace data and any combination thereof. In preferred embodiments, the at least one library is a validated library. In preferred embodiments, the at least one library is an updated library. In preferred embodiments, the database is a global database. In some embodiments, the database comprising at least one library comprises a plurality of libraries. In preferred embodiments, the database is maintained and managed by an entity other than that performing the step of collecting data.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

or a more complete understanding of the present invention, reference is now made to the following descriptions taken in conjunction with the accompanying drawing, in which:

FIG. 1 is a block diagram schematically illustrating the steps to develop, maintain and update the database and to remotely analyze a sample.

FIG. 2 is a schematic depicting the configuration of the database system.

### DETAILED DESCRIPTION OF THE INVENTION

As used herein, “a” or “a” is defined herein as one or more. The singular includes the plural and the plural includes the singular unless otherwise stated.

As used herein, the term “central facility” is intended to be defined broadly and refers to one or more locations where analytical data resides. The central facility may be large or small, and may comprise a facility with equipment and instrumentation which may be used to generate analytical data. Alternatively, it may also simply consist of a computer or other data storage device where the uniquely identifiable information resides.

As used herein, the term “centrally”, when referring to the maintenance and management of databases, refers to the upkeep of databases by a single entity. However, this single entity may be a group of entities such as an industry group or trade group. The entity may also include one or more government agencies. The “central facility”, as used herein, also encompasses a series of facilities that house databases, and is not limited to one facility at one location. The single entity, group of entities, individual or group of individuals is distinct from the one or more users/subscribers or from the aggregate group of users/subscribers. As a non-limiting example, a single entity or group of entities could be a single pharmaceutical company or a group of pharmaceutical companies, and the user/subscriber could be a larger group of pharmaceutical companies of which the single entity or group of entities is a part.

As used herein, “comparing” is broadly defined to include both qualitative and quantitative (i.e., mathematical or statistical) comparison. Thus, “comparing”, when used in reference to analytical data for a sample and validated data for example, in a validated library, encompasses any and all methods of comparison. These encompass mathematical correlation or modeling or other statistical or mathematical methodologies, and it also encompasses qualitative comparisons. “Comparing” as used herein encompasses all techniques of comparison.

As used herein, the term “data” is broadly defined to include all forms of data and data files.

As used herein, the term “entity” is defined in the business sense as an individual concern or association. In this way, it may refer to different (unrelated) business entities, or it may refer to a government agency or group of agencies, such as a regulatory group. It may also refer to a trade group or other group consisting of multiple companies or corporations; the collective union of them into a group constitutes an entity.

As used herein, the term “global”, in reference to a database of information for pharmaceuticals refers to a database of information of products from multiple manufacturers including multiple dosage forms, multiple strengths, multiple formulations, etc.

As used herein, the term “information”, is broadly defined and includes all data, including both quantitative and qualitative data.

As used herein, the term “instrument”, in reference to devices to measure analytical data for a sample of pharmaceutical material is to be construed broadly; encompassing both sophisticated forensic instruments such as spectrometers, and relatively simple devices such as a barcode reader or even the human eye for visual observation.

As used herein, the term “maintain and manage” in reference to databases, refers to any combination of, or all of, validation, certification, updating and upkeep, as well as any other maintenance and upkeep procedures known to those of skill in the art, the practice of which is designed to insure that the database is current and suitable for its ongoing, real-time use.

As used herein, “pharmaceutical material” is broadly defined as any one component or more than one component of a pharmaceutical product, or the entire pharmaceutical product itself, including, but not limited to, packaging materials, active pharmaceutical ingredients, excipients, inactive pharmaceutical ingredients, pharmaceutical dosage forms of all varieties, etc., and any single component, sub-component, or mixture of components of a pharmaceutical composition or product. The term “pharmaceutical material” encompasses finished pharmaceutical dosage forms, pharmaceutical ingredients, and any pharmaceutical sample.

As used herein, “pharmaceutical supply chain” is broadly defined as the pathway for which a pharmaceutical material may travel from the pharmaceutical manufacturer to the patient including, but not limited to, pharmaceutical manufacturers, drug distribution centers, drug repackaging facilities, ports-of-entry, customs facilities, import facilities, mail facilities, regulatory centers (whether or not they are run by the government), government centers (such as law enforcement centers but also including government regulatory centers), pharmacies, hospitals, dispensaries, clinics, assisted-living facilities.

As used herein, “finished pharmaceutical dosage form” includes any and all possible finished dosage forms, including, but not limited to oral dosage forms, injectables, transdermals, suppositories, ophthalmics, inhalants, etc.

As used herein, “pharmaceutical ingredient” is defined as any sub-component of a pharmaceutical product, including, but no limited to, active pharmaceutical ingredients, excipients, pharmaceutical raw materials, pharmaceutical mixtures, and pharmaceutical packaging materials.

As used herein, the term “authenticate” refers to the action of making a determination regarding authenticity. To “authenticate” refers to action of determining whether a sample of pharmaceutical material is authentic or counterfeit. For medication errors, to “authenticate” refers to the action of determining whether a sample is being dispensed correctly or as prescribed.

As used herein, “product information” is defined as any information that can be used to uniquely identify an authentic drug product including, but not limited to, images of products, packaging and labeling attributes, product codes, lot numbers, expiration dates, and data from track and trace technologies such as barcode information, radio-frequency identification contained in radio-frequency identification chips and other electronic and non-electronic media.

As used herein, “forensic information” or “forensic data” is defined as any information or data that can be used to uniquely identify an authentic drug product. This includes analytical data such as spectroscopic (NIR, Raman, and others) and non-spectroscopic data (dissolution, chromatographic, and others), that utilize the inherent chemical and physical characteristics of the product, but also includes other data useful to positively identify pharmaceutical materials, including, but not limited to chemical markers, taggants and packaging materials. Forensic information or forensic data are classes of uniquely identifiable information. A “forensic method” is any method that produces forensic information or forensic data.

As used herein, “pharmaceutical manufacturer-verified genuine material” refers to any pharmaceutical material that is verified by the original manufacturer to be authentic pharmaceutical material demonstrated by tracking protocols include but are not limited to documented evidence of chain-of-custody, proof-of-control and product pedigree.

As used herein, “uniquely identifiable information” is the term used to describe any information (i.e., data) about a pharmaceutical material and can be used to identify the material, track and trace the material or determine its authenticity. This includes forensic chemical data such as spectroscopic (NIR, Raman, and others) and non-spectroscopic data (dissolution, chromatographic, and others), but also includes other data useful to positively identify pharmaceutical material, including, but not limited to packaging information, and data from track and trace technologies such as barcode information, radio-frequency identification contained in radio-frequency identification chips and other electronic and non-electronic media. Track and trace technologies includes the examples given as well as other varieties currently available and those yet to be developed.

As used herein, “pharmaceutical sample” is defined as any portion of, or all of, some pharmaceutical material. This also includes the entire amount of a recovered pharmaceutical material.

As used herein, the term “remote site” is defined as a testing site where data collection in the field is performed. Although they are typically at a different location from the central facility, this is not absolutely necessary.

As used herein, the term, “satellite instrument” is defined as a data collection instrument (including the base instrumental platform and any associated instruments), typically located at a remote site, which is used to collect data on a sample of pharmaceutical product. The satellite instrument can be in communication with a database at a central facility.

As used herein, the term “subscriber” means any user of the analytical database and is typically, but not necessarily, the remote collector of analytical information seeking to verify authenticity. The term “user” is synonymous and interchangeable with the term “subscriber” in reference to the entity that receives data from the central facility.

As used herein, the term “library”, defines a collection of similar information contained within the database.

As used herein, “updated” or “updating”, in reference to a library or database is defined as a revision which may involve the addition or removal of data, revision of methods or types or classes of data, and revalidation. The frequency of updating can be periodic (occurring at regular intervals) or intermittent, or both periodic and intermittent.

As used herein, the term “validation”, in reference to libraries of uniquely identifiable information, refers to a process by which systematic testing protocols are used to verify that the uniquely identifiable information, when applied in the analysis of a sample of pharmaceutical material, will yield accurate, precise, and reproducible results. Where applicable, the threshold levels of accuracy, precision, and reproducibility are determined with reference with generally accepted Good Manufacturing Practices (GMPs) in the pharmaceutical industry.

The present invention provides a means by which one or more users, preferably at remote (satellite) sites along the pharmaceutical supply chain of pharmaceutical material such as finished pharmaceutical dosage forms, can collect data for a given sample of pharmaceutical material and access an established database having a comprehensive library of uniquely identifiable information for the pharmaceutical material. Preferably, the pharmaceutical material is finished pharmaceutical dosage forms. Optimally, the database is validated, maintained, and updated. The comprehensive libraries are housed in a central facility. Communication between the user and the central facility may be accomplished by any means, including, but not limited to, wired, wireless, fiber optic, etc., but is most preferably done through internet connections or any secured data connections. Subscribers then have access to a universal, trouble-free access to a centrally maintained and managed, secure database of uniquely identifiable information, enabling the use of rapid, non-destructive remote tests for authenticity of pharmaceutical material. The central facility will comprise validated and updated database of uniquely identifiable information for commercially available finished pharmaceutical dosage forms, preferably from multiple manufacturers. Preferably, access would be available to all users in the distribution chain for viewing and contributing to the authentication and/or the tracking of a particular product. However, other either broader or narrower access arrangements, while less preferable, are within the scope of the present invention. Access to the database is preferably controlled by protocol and limited to qualified users in the distribution chain for viewing and contributing to the authentication and/or the tracking of a particular product. Proprietary information owned by the manufacturers should be accessible only in encrypted formats for use in comparison algorithms.

Preferably, the database is managed and maintained by an entity distinct from the entity which will use the database for identification and verification. For example, the database may be managed and maintained by an independent company outside of those entities involved in the pharmaceutical industry and supply chain, or by a government agency and subscribers may be any others in the pharmaceutical industry (including pharmaceutical companies, distributors, shippers, pharmacists, doctors, other health care professionals, etc.) as well as pharmaceutical consumers. Alternatively, the database may be managed and maintained by and industry group such as a group of pharmaceutical companies and/or others). Central maintenance and management of the database is preferred in order to promote the integrity and independence of the system. The system is preferably used to verify authenticity of pharmaceutical material and to interdict counterfeit pharmaceutical material in the pharmaceutical supply chain. However, it is also applicable to related applications, such as the identification of medication errors or packaging errors. Preferably, the entity which manages and maintains the database may be an independent entity is not otherwise involved in pharmaceutical manufacturing and/or distribution. In this way, independence is maintained and libraries of data for pharmaceutical material from multiple manufacturers may populate the database. The entity which manages and maintains the database may be a consortium of pharmaceutical manufacturers or it may be a government regulatory agency. These are non-limiting, illustrative examples and one of skill in the art will immediately understand the other possibilities which are a part of the present invention. Alternatively, the database need not be managed and maintained by an entity distinct from the entity which will use the database for identification and verification.

Centralized, preferably independent, maintenance and management of the database promotes its integrity. For this reason, this is the preferred arrangement. The global database may be rendered less effective by introduction of data which is not as highly correlated to the unique characteristics inherent to the product. The discrimination capability of the product database is highly dependent on information which is representative of “authentic product variability.” Multiple, independently developed product information libraries could introduce variability associated with non-standardized instrumentation, testing environments, methodology, and experimental technique. This type of poorly correlated variability could lead to inaccurate product authentication or the dispensing of “non-authentic product.”

The libraries which comprise the database may be cataloged according to any method. In other words, the libraries may be based upon manufacturer, dosage form, time of manufacture, etc. This list is illustrative and not exhaustive. In this way, a library may be large or small or of intermediate size. It merely indicates a collection of data. A library (or a data file generally) “corresponds” to a sample if it shares any commonality with the sample to allow for authentication. For example, if the sample under study is a tablet, a library would correspond to the sample if it has at least some data for tablets. As another example, if the sample is a pharmaceutical material ostensibly manufactured by manufacturer “X”, then a corresponding library could have at least some data for pharmaceutical material manufactured by manufacturer “X.” The above examples are non-limiting examples. They are merely illustrative and non-exhaustive. As would be known to one of skill in the art, a corresponding library would share some commonality with the sample such as to facilitate authentication, identification, counterfeit determination, etc. Other examples are possible and understood by one of skill in the art.

Thus, there is a pharmaceutical authenticity verification system having a database having at least one library of uniquely identifiable information for finished pharmaceutical dosage forms. The database comprises data which is primary reference master data. While data may be transferred to locations remote from the central database, its presence and maintenance at the central facility result in one reference data center analogous to a primary standard. The data may be any data that yields uniquely identifiable information for a particular pharmaceutical material. Ideally, the database is a global database, containing all dosage forms available, all strengths available and for product produced by all manufacturers, both generic and original. The database is also preferably validated according to industry good manufacturing practices (GMPs) appropriate for the specific circumstances; i.e., type of dosage form, choice of forensic method and resulting data, etc. Preferably, the database should be updated regularly or intermittently, or both regularly and intermittently, in order to insure that it possesses data that reflects up-to-date information for a given product. Regular updates account for slow systematic changes in formulations or changes in labeling or packaging that occur over time, while intermittent updates would be used to capture sudden changes such as those likely to be seen as a result of process changes or changes in manufacturing formulas, ingredients, etc. A primary virtue of the present system is realized when the database is remote from the sample data collection. This allows for ready testing at any and all points in the distribution chain of a pharmaceutical product by relieving the data collector of the need to compile, update, and maintain the necessary database. This cumbersome task may be performed centrally, and the user merely becomes a database subscriber.

The resulting methods of authentication are preferably computer-driven, wherein the sample data collected is compared to one or more libraries in the database in order to determine authenticity. Algorithms for the comparison and determination are well known in the art and others may be easily written; it is envisioned that any of these methods or any later developed should be applicable in the present invention. Computer-driven protocols allow for the use of various security devices such as encryption and others know in the art, as well as those to be developed.

At the remote location, the data collected may be of any nature sufficient to provide uniquely identifiable information of the material. This may be data as complex as forensic data; i.e., comprising chemical or physical parameters which are measured and compared to the data in the centrally-maintained, validated libraries. Alternatively, it could be very simple information, such as packaging or labeling attribute information (e.g., one non-limiting example of such could be as follows: product X has a label having blue lettering with a specific print font on a white background). This information is then compared, through suitable mathematical algorithms or other electronic means, to the library of authentic product to confirm the identity and, origin of the sample. Because it may contain analytical data in the broader sense, which includes packaging information (such as dimensions of the packaging, colors, lettering, etc.) and/or track and trace technologies (i.e., tags): such as barcode information, radio-frequency identification chips and other track and trace technologies, it potentially provides the user with multi-dimensional data to positively identify material. Because the master library is large enough to recognize typical process variations in the finished product, it is robust enough in its recognition of typical process variations such that false negatives can be avoided. However, it is sensitive enough to detect truly counterfeit product, the latter is typically characterized by the complete absence of one or more ingredients in the finished pharmaceutical dosage form, and/or variations in packaging and/or non-conformance to various track and trace technologies. It is preferable to utilize multiple parameters in the determination of authenticity. As one of skill in the art recognizes, the ability to identify counterfeit material is enhanced when multiple parameters are used. For example, near-infrared and/or Raman spectroscopic information could be combined with packaging analysis: and a track and trace test such as radio frequency identification. Any and all possibilities are useful and are within the scope of the present invention.

In some embodiments, it is possible and sometimes desirable for the user at the remote location to introduce data into the central database. For example, this is particularly desirable where track and trace technologies are used. It will then be possible to track a pharmaceutical material at some point after its manufacture through the distribution chain to the end consumer or alternatively to some intermediate point in the distribution chain. This is particularly useful in the case of barcode tracking or radio frequency identification tracking. Such electronic pedigrees, when part of a rigidly controlled distribution system, would represent a formidable hurdle to successful counterfeiting activities.

It is possible in some applications that the user does not collect any analytical data or other information from a sample of pharmaceutical material. The most obvious example of such a scenario would be a simple visual inspection of a package and contents of a finished pharmaceutical dosage form (such as tablets) and merely receives information from the central facility. In such case, it is possible that the user merely makes visual observations and compares these observations with information received from the database.

In the case where specific analytical instruments are used at the remote testing locations, it is preferable to employ mass produced instruments with identical responses. Such instruments are now available and are expected to become more common. In this way, consistent, reproducible results can be achieved while minimizing false negatives and false positives. An independent, centrally maintained and managed database results in the efficient storage, retrieval, dissemination, and protection of proprietary information.

The most effective method for securing the global database is to develop and maintain a single, isolated, encrypted, master reference data base (with redundant masters). Subscriber interfaces preferably will use random, encrypted data transmitted to secondary servers which are physically isolated from the master to allow for secure communication with subscriber sites. Central maintenance and management also effectively eliminates the introduction of rogue information and duplication of “authentic” product information into and out of the global database. Counterfeit technologies cannot be used to alter the product information database. The inability to alter the database will help prevent the dispensing of non-authentic product.

The database comprising the master libraries preferably should have library information for all commercially available dosage forms for any given drug. Preferably, the database should comprise at least one library, or it may comprise a plurality of libraries. The data can be of any form that can be used to uniquely identify a drug product, and more broadly, any pharmaceutical material. The database includes data libraries for any and all oral dosage forms including but not limited to, tablets and capsules; as well as any other dosage form, including but not limited to, injectables, inhalants, intraveneous solutions, transdermals, suppositories, ophthalmics, and combinations thereof, etc. This list is intended to be illustrative and not exhaustive; one of ordinary skill in the art recognizes that any dosage form which is subject to conventional analysis can be tested according to the present invention. It should be noted that although finished pharmaceutical dosage forms are likely to be the most commonly encountered counterfeit pharmaceutical material, the database and method of the present invention may be used with pharmaceutical materials other than finished dosage forms. Thus, the remote testing of active pharmaceutical ingredients, pharmaceutical raw materials, and pharmaceutical packaging materials, among others, may be realized through the use of the database and method of the present invention. The testing of packaging materials including, but not limited to, ink and carton composition or polymer composition from a sample of pharmaceutical product recovered in the field can also inform as to authenticity.

Preferably, the master library is updated to account for legitimate product information and formula and process changes by manufacturers. Furthermore, the master library is updated with pharmaceutical manufacturer-verified genuine, material collected from the supply chain to establish data that represents manufacturer recommended storage and handling information. Updated and validated data, preferably supplied by the manufacturer insures a high quality reference library and minimizes false positives and, importantly, false negatives. Regular updates insure that an accurate picture of the body of product produced by a manufacturer is represented in the master library. Although not required, the master library may also include analytical data of known counterfeit products. Such information is useful not only in confirming the counterfeit nature of a recovered sample, but whether alone or when coupled with complimentary information such as the geographic location where the sample was found, packaging and/or labeling attributes and other characteristics of the sample, etc., may assist law enforcement and other authorities in investigating and locating the source of the counterfeit material. Packaging attributes include, but are not limited to, package dimensions, labeling print style, etc.

Preferably, data transmitted from the central facility will be data in the form of encrypted algorithms. In this way, security is enhanced and the system will be less prone to data corruption.

Although the primary utility of the present invention lies in the verification of authenticity of the pharmaceutical product, it may also be used to remotely monitor other pharmaceutical quality parameters such as assay, content uniformity; etc. to ensure supply compliance for storage and handling. It could also be used to detect unauthorized deviations in products by otherwise legitimate manufacturers. Deviations from established specifications for these parameters may be used to identify product tampering. It may also be used to identify medication errors to further promote the health and safety of the pharmaceutical consumer. In these applications, the basic methodology and database are used.

Satellite instruments used to interrogate samples for authenticity could be located anywhere where communication with the central facility is possible. Preferably using an internet communications link, the possible sites to locate a satellite instrument become almost limitless. However, any and all forms of communication are within the scope of the present invention. It is possible that, initially, the satellite instruments can be loaded with data from the central database and/or provided with a memory storage device (such as a disk). In such cases, updates are then performed remotely through communication with the central facility as described herein. Ideally, the satellite instruments would be placed at prominent points along the pharmaceutical supply chain. This includes, but is not limited to pharmaceutical manufacturers, drug distribution centers, drug repackaging facilities, ports-of-entry, customs facilities, import facilities, mail facilities, government/regulatory centers, pharmacies, hospitals, dispensaries, clinics, assisted-living facilities. However, due to the portable nature of many modern analytical instruments, satellite instruments can be used anywhere that counterfeit pharmaceutical products may be found or where medication errors may occur.

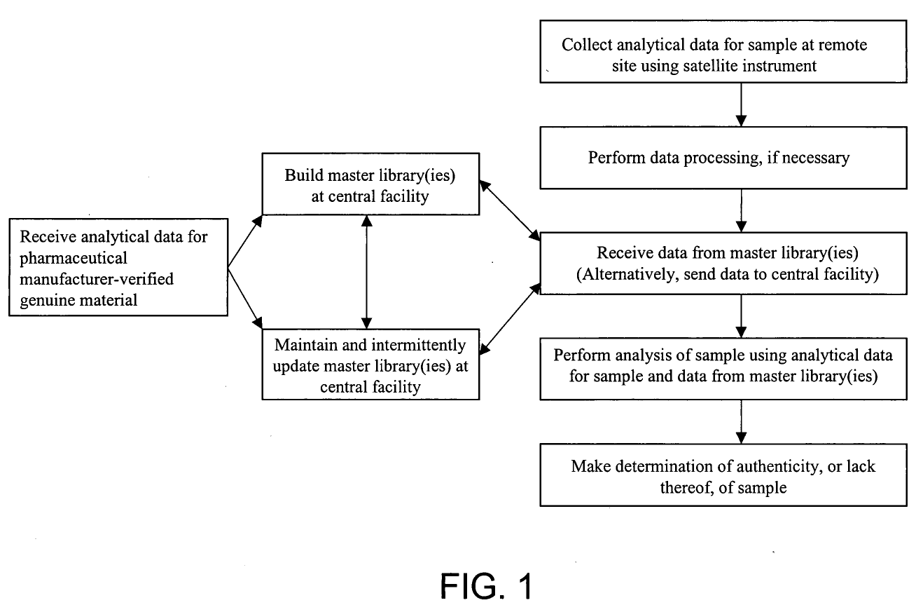

FIG. 1 provides a flow diagram illustrating a preferred embodiment of the invention. Initially, data for a pharmaceutical manufacturer-verified genuine product is introduced to the database an the library(ies) of uniquely identifiable information are periodically updated as product information or formulations are revised. Data for a sample to be authenticated is collected and processed, if necessary, at the remote site. Preferably, data from the central facility is sent to the remote site for analysis against the data collected. In this way, the central facility merely maintains the data libraries as validated and updated data references for comparison to (i.e., analysis of) the data collected at the remote sites. A final determination is then made. In an alternative embodiment (not shown in FIG. 1), the data collected for the sample at the remote site could be sent to the central facility with or without data processing. In such a case, the remote site could yet receive data from the master library, although this is not absolutely necessary. The analysis and final determination regarding authenticity may also be performed at the central location in this alternative embodiment. One of skill in the art readily sees that other variations are possible with different tasks assigned to either the central facility or the remote site.

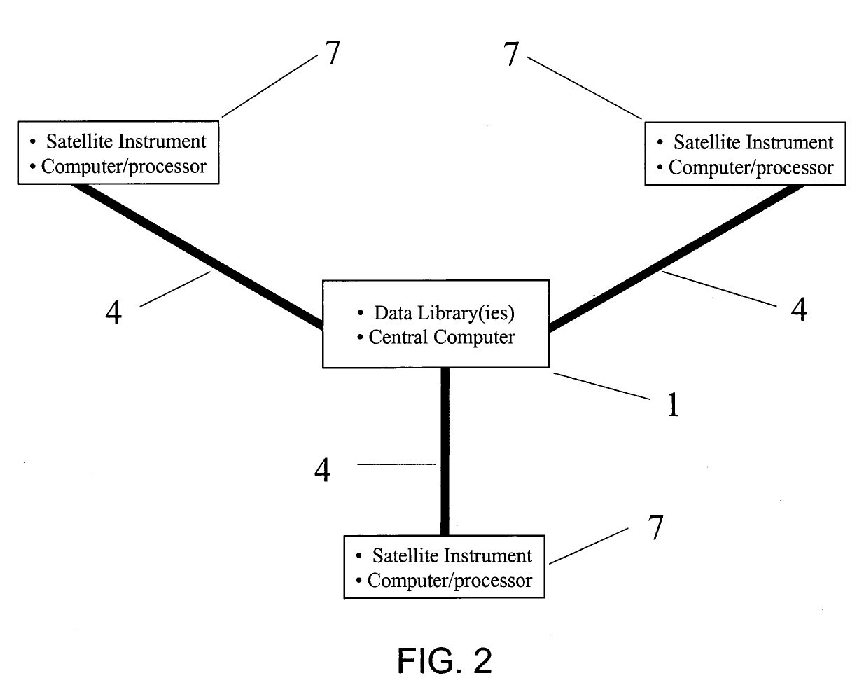

FIG. 2 schematically illustrates the preferred relative configuration of the central database facility and the remote testing sites. In FIG. 2, the library data and central computer is maintained at the central facility (1), which is in communication (4) with the remote testing facility (7). The central facility (1) comprises a central computer and the data library(ies). The remote testing facility (7) comprises a satellite instrument and a computer/processor. As shown in FIGS. 1 and 2, data may flow in any direction; i.e., to and from both the central database and the remote testing sites. Additionally, it, is possible that analysis of samples can occur at either the central facility or the remote sites. For example, data from the libraries may be sent from the central facility to one or more remote testing sites, wherein the remote testing sites uses the data transferred from the central facility to perform analysis of data it has collected. Similarly, data collected at the remote sites may be transferred to the central facility wherein it is analyzed against libraries in the database in order. The invention herein contemplates the transfer of data in either direction and the analysis of data at either the remote sites or the central facility, although in some embodiments, information only travels from the database at the central facility to the user.

Although the invention is not so limited, the following description considers the integration of machine-readable or automatic identification technology with forensic technology for use, in the present invention. Given the increasing sophistication of counterfeiting, use of multiple libraries of uniquely identifiable information will greatly increase the ability to detect counterfeit drugs at point of entry into the supply chain. In the case of medication errors, multiple libraries of uniquely identifiable information will ensure that medications are dispensed correctly when non-standard identification technology is employed or unit-of-dose administration is performed in which identification technology is not available.

Because of the need to uniquely identify pharmaceutical materials passing through the supply chain, machine-readable or automatic identification technologies i.e., barcode technology using linear (or one dimensional) symbology is particularly suited for application in the present invention. One of ordinary skill in the art will immediately recognize that the present system and method are equally applicable to other machine-readable or automatic identification technologies utilizing other symbologies such as two-dimensional symbology, reduced space symbology, composite symbology, non-linear symbology or radio frequency identification that provide uniquely identifiable product information including, but not limited to, product specific and packaging specific codes, dosage, strength and form, lot number and expiration date. The example given is intended to be merely illustrative and not exhaustive.

Owing to multi-component nature of typical finished pharmaceutical products, forensic techniques such as IR, Raman, Near-IR, UV, UV-VIS, fluorescence, chemical imaging, microwave, X-ray or acoustic spectroscopy and other techniques that can uniquely identify a pharmaceutical material based upon its inherent chemical formulation or other techniques which utilize chemical markers or taggants are particularly suited for application in the present invention. Enabling technologies including, but not limited to, diode arrays and micro-optical electronic components that can be integrated into small handheld devices are particularly suited to for application in the present invention. One of ordinary skill in the art will immediately recognize that the present system and method are equally applicable to other forensic techniques that utilize reference libraries or other reference standards for comparison including, but not limited to, mass, spectrometry and gas and liquid chromatography. The example given is intended to be merely illustrative and not exhaustive. Preferably, the authentication is itself multi-dimensional, preferably using more than one form of data for its final determination. For example, a determination may utilize Near-IR and packaging information, and/or some other data form. In this way the discrimination ability of the test is better suited for the complexity of the multi-component nature of typical finished pharmaceutical products.

Because of the enormous number of pharmaceutical products presently on the market, it is desirable that workers in the industry have ready access to numerous libraries of uniquely identifiable information. This would include data for brand names well as generic products. As is typical in the industry, manufacturers oftentimes produce a given finished pharmaceutical dosage form in a variety of manufacturing sites around the world. In such cases, various ingredients are procured from different sources. The particular set of data should include all the potential variations of authentic product. As manufacturers continually update manufacturing formulas, sources of raw materials, manufacturing processes, etc., in an effort to hold down costs and improve quality, a need exists for a centralized library of uniquely identifiable information which is regularly updated for any of such manufacturing changes or any other changes.

The first step in the application of the method of the present invention is construction of the centrally-housed library. Uniquely identifiable information for a pharmaceutical sample is collected from a pharmaceutical manufacturer-verified genuine material or entered as received from a pharmaceutical manufacturer. A variety of algorithms and matching routines are available to compare the product information contained within the database. A variety of chemometric or statistical methods including, but not limited to, correlation, wavelength distance, SIMCA, Principal Component Analysis (PCA), K Nearest Neighbor (KNN), and Polar Center of Gravity (PCG) that can be used to identify and qualify pharmaceutical materials so that the forensic library would, be specific for a particular pharmaceutical material and the forensic data can be used to confirm authenticity.

The second step in the application of the method of the present invention is to acquire data for a pharmaceutical sample. Automatic identification information is collected using a barcode wand. Forensic information is collected by scanning the sample using an appropriate instrument. This acquired data is then compared with data contained within the library for pharmaceutical manufacturer-verified genuine material.

The final step in the application of the method of the present invention is to authenticate (or not) the pharmaceutical sample. To identify counterfeit drugs in the supply chain, comparison is made between the product information contained within the barcode symbology of the sample and the barcode symbology for the pharmaceutical manufacturer-verified genuine product. Authenticity is determined by a conclusive match between the sample information and the pharmaceutical manufacturer-verified material information. The threshold determination of whether a match has been found is variable and may differ according to the circumstances. In instances where authenticity cannot be confirmed, or is suspect, forensic analysis may be used to confirm authenticity (or not) by collecting sample data and performing a statistical comparison between the sample data and pharmaceutical manufacturer-verified sample data. It will be obvious to one skilled in the art, that the reverse data acquisition routines could be used for authentication, that is, forensic analysis followed by product analysis.

To confirm medication is dispensed correctly, comparison is made between the product information contained within the barcode symbology of the sample and the barcode symbology for the pharmaceutical manufacturer-verified genuine product. Authenticity is determined by a conclusive match between the sample information and the pharmaceutical manufacturer-verified material information. In instances where product information is not available, such as unit-of-dose product, forensic analysis may be used to confirm that the right drug and the right drug is being dispensed or administered to the right patient. Chain-of-custody for medication administration is also obtained by scanning a barcode on a nurse's ID badge and a patient's wristband. It will be obvious to one skilled in the art, that the reverse data acquisition routines could be used for authentication, that is, forensic analysis followed by product analysis.

Although the bulk of the discussion provided herein focuses on solid dosage formulations (tablets, capsules, etc.), it understood by those of skill in the art that the method is applicable to any pharmaceutical material. Other pharmaceutical products, including other oral dosage forms such as capsules, etc., and other dosage forms such as parenterals (injectables), intravenous solutions, transdermals, suppositories, ophthalmics, etc., may be analyzed using the present invention. It may even be used to identify bogus material taking the form of a pure component, examples include active pharmaceutical ingredients, excipients and other inactive ingredients and pharmaceutical raw materials. The method is also applicable to the identification of authenticity through the testing of packaging material including, but not limited to polymer materials used in blister packaging, ink composition and paper composition. Recovery of a sample having material inconsistent with the known sources of the manufacturer can be used to identify counterfeit product.

Centrally locating the database is preferable because it facilitates central maintenance, validation, and update of the global image libraries. The independent nature of central management and maintenance also promotes the integrity of the database. It is preferable, however, that the independent entity maintaining and managing the database work closely with manufacturers of pharmaceutical materials. Typically, pharmaceutical manufacturers frequently modify pharmaceutical processes used in the formulation of finished product, as well as the processes used to produce the pharmaceutical raw materials, excipients, and actual drug substances. Physical properties such as particle size and crystallinity may change due to minor process changes such as the substitution of one recrystallization solvent with another, among others. Similarly, pharmaceutical packaging changes may be implemented, as well as changes in track and trace methodologies such as modified barcodes and other “tags” such as radio-frequency identifiers. Any of these changes may lead to false negatives for genuine samples of pharmaceutical product where the reference library has not been updated and therefore does not account for product produced after the process change. The above remarks apply with equal force to change in ingredients of the formulation. While such modification generally occur less frequently than either pharmaceutical or chemical process changes, their frequency of occurrence nevertheless warrants updates of the various libraries in the database.

In another application of the present invention, distinct libraries can be constructed which possess only those manufacturing and formulation updates which have been introduced through required regulatory procedures. Thus, these libraries can be used to detect unauthorized changes to pharmaceuticals. Specific procedures, typically involving the formal reporting changes to approved products along with submission of supporting data, are required to maintained compliance with regulatory rules and statutes. Formal reporting typically involves a regulatory filing. Special libraries may be constructed which contain information for approved product only. Such “regulatory” libraries, when applied in the central database of the present invention, can provide a boon to regulatory enforcement of unauthorized process changes, and other unauthorized changes to pharmaceutical products. While manufacturer-produced products are not counterfeit products per se, they are viewed as adulterated products by regulatory authorities, and their identification typically requires an off-line forensic procedure to detect adulteration in various locations along the pharmaceutical supply chain. Application of the present invention to this problem allows for the rapid, reliable, real-time analysis of suspect material.

In addition to the entry of new and modified versions of drug product, new counterfeit versions of popular drug products enter the market on a regular basis. For the database and method of the present invention to successfully detect counterfeit product with the high rate of success, it is important that the libraries contained in the central database be maintained by timely updates. There is no absolute frequency with which updates must be performed, however, it is preferable that these be performed often enough to insure that the database libraries recognize all pharmaceutical products legitimately present in the marketplace at any given time.

While the invention is not so limited, one preferred form of data is spectroscopic data relating to the pharmaceutical material. Many spectroscopic methods are amenable to quick, accurate, reproducible, and precise results in real-time. Accordingly, data transferred form the central database could comprise up-to-date validated spectroscopic information relating to the pharmaceutical material. Preferably, near-infrared (Near-IR) and/or Raman spectroscopic data and chemical imaging data may be used.

Spectroscopic information is product specific, unique, and cannot be duplicated. However, any spectroscopic or even non-spectroscopic chemical or physical data may also be used. A given form of data will be more or less optimal depending upon its amenability to quick, accurate, reproducible, and precise results in real-time. Nevertheless, other data forms less congruent with these attributes are also useful in the present invention, particularly when used in conjunction with these methods.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the subject matter disclosed is intended to include within its scope such processes, machines, manufacture, compositions of matter, means, methods, or steps.

What is claimed is:

1. A centrally maintained and managed information database system comprising:
data comprising at least one library of uniquely identifiable information for finished pharmaceutical dosage forms, said at least one library having uniquely identifiable information for finished pharmaceutical dosage forms manufactured by more than one manufacturer;
a central facility to house said data and to receive and/or transfer information to or from at least one user; and,
a communication link between said central facility and said user.

2. The information database system of claim 1 further comprising at least one satellite instrument at a local testing center remote from said central facility.

3. The information database system of claim 2 wherein the local testing center is located at a site in the supply chain of said pharmaceutical material.

4. The information database system of claim 3, wherein said site is selected from the group consisting of pharmaceutical manufacturers, drug distribution centers, drug repackaging facilities, ports-of-entry, customs facilities, import facilities, mail facilities, government centers, regulatory centers, pharmacies, hospitals, dispensaries, clinics, assisted-living facilities, and any combination thereof.

5. The information database system of claim 1, wherein said at least one library comprises data collected from forensic methods selected from the group consisting of near-infrared spectroscopy, infrared spectroscopy, UV-VIS spectroscopy, fluorescence spectroscopy, phosphorescence spectroscopy, Raman spectroscopy, microwave spectroscopy, photo-acoustic spectroscopy, X-ray spectroscopy, chemical imaging, and any combination thereof.

6. The information database of claim 1, wherein said at least one library comprises data selected from the group consisting of images of products, packaging attributes, labeling attributes, product codes, lot numbers, expiration dates, track and trace data, and any combination thereof.

7. The information database system of claim 1, wherein the communication link comprises an internet link.

8. The information database system of claim 1, wherein the database system further comprises a library of analytical information of known counterfeit finished pharmaceutical dosage forms.

9. The information database system of claim 1, wherein the pharmaceutical material comprises a finished pharmaceutical dosage form selected from the group consisting of oral dosage forms, injectables, inhalants, intravenous solutions, transdermals, suppositories, ophthalmics, and combinations thereof.

10. The information database system of claim 1, wherein said at least one library is a validated library.

11. The information database system of claim 1, wherein said at least one library is an updated library.

12. The information database system of claim 1, wherein the database system is a global database system.

13. The information database system of claim 1, wherein said database is maintained and managed by an entity distinct from said at least one user.

14. The information database system of claim 1, wherein said data comprising at least one library comprises a plurality of libraries.

15. The information database system of claim 1, wherein said central facility transfers data to said at least one user.

16. A centrally maintained and managed information database system comprising:
data comprising at least one library of uniquely identifiable information for pharmaceutical material selected from the group consisting of active pharmaceutical ingredients, excipients, pharmaceutical raw materials, pharmaceutical packaging materials, and combinations thereof, said pharmaceutical material manufactured by more than one manufacturer;
a central facility to house said data and to receive and/or transfer information to or from at least one user; and,
a communication link between said central facility and said user.

17. The information database system of claim 16, wherein said at least one library comprises data collected from forensic methods selected from the group consisting of near-infrared spectroscopy, infrared spectroscopy, UV-VIS spectroscopy, fluorescence spectroscopy, phosphorescence spectroscopy, Raman spectroscopy, microwave spectroscopy, photo-acoustic spectroscopy, X-ray spectroscopy, chemical imaging, and any combination thereof.

18. The information database of claim 16, wherein said at least one library comprises data selected from the group consisting of images of products, packaging attributes, labeling attributes, product codes, lot number, expiration dates, track and trace data, and any combination thereof.

19. The information database system of claim 16 further comprising at least one satellite instrument at a local testing center remote from said central facility wherein said local testing center is located at a site in the supply chain of said pharmaceutical material.

20. The information database system of claim 19, wherein said site is selected from the group consisting of pharmaceutical manufacturers, drug distribution centers, drug repackaging facilities, ports-of-entry, customs facilities, import facilities, mail facilities, government centers, regulatory centers, pharmacies, hospitals, dispensaries, clinics, assisted-living facilities, and any combination thereof.

21. The information database system of claim 16, wherein said at least one library is a validated library.

22. The information database system of claim 16, wherein said at least one library is an updated library.

23. The information database system of claim 16, wherein the database system is a global database system.

24. The information database system of claim 16, wherein said database is maintained and managed by an entity distinct from said at least one user.

25. The information database system of claim 16, wherein said data comprising at least one library comprises a plurality of libraries.

26. The information database system of claim 16, wherein said central facility transfers data to said at least one user.

27. A method for the determination of authenticity of a sample of pharmaceutical material comprising:
collecting data for said sample of pharmaceutical material at a remote location;
transmitting information to or receiving information from, a central facility having a database comprising data, said data comprising at least one library of uniquely identifiable information for authentic pharmaceutical material corresponding to said sample, said database comprising data for pharmaceutical material manufactured by multiple manufacturers; and,
comparing said data for said sample of pharmaceutical material to said data comprising at least one library.

28. The method of claim 27, further comprising the step of processing said data for said sample of pharmaceutical material.

29. The method of claim 27, wherein said at least one library is constructed from manufacturer-verified pharmaceutical material.

30. The method of claim 27, further comprising the step of supplementing the library with the analytical data collected for said sample at said remote location.

31. The method of claim 27, further comprising the step of collecting assay data relating to said sample.

32. The method of claim 27, wherein said sample comprises a pharmaceutical ingredient.

33. The method of claim 32 wherein said pharmaceutical ingredient comprises a pharmaceutical ingredient selected from the group consisting of active pharmaceutical ingredients, excipients, pharmaceutical raw materials, pharmaceutical mixtures, pharmaceutical packaging materials, and combinations thereof.

34. The method of claim 33 wherein said pharmaceutical ingredient is a pharmaceutical mixture.

35. The method of claim 34 wherein said pharmaceutical mixture is a granulation.

36. The method of claim 27, wherein said data comprising at least one library comprises data collected from forensic methods selected from the group consisting of near-infrared spectroscopy, infrared spectroscopy, UV-VIS spectroscopy, fluorescence spectroscopy, phosphorescence spectroscopy, Raman spectroscopy, microwave spectroscopy, photo-acoustic spectroscopy, X-ray spectroscopy, chemical imaging, and any combination thereof.

37. The method of claim 27, wherein said data comprising at least one library comprises data selected from the group consisting images of products, packaging attributes, labeling attributes, product codes, lot numbers, expiration dates track and trace data, and any combination thereof.

38. The method of claim 27, wherein said at least one library is a validated library.

39. The method of claim 27, wherein said at least one library is an updated library.

40. The method of claim 27, wherein said database is a global database.

41. The method of claim 27, wherein said database is maintained and managed by an entity other than that performing the step of collecting.

42. A method for the determination of authenticity of a sample of finished pharmaceutical dosage form comprising:
collecting data for said sample of finished pharmaceutical dosage form at a remote location;
transmitting information to or receiving information from, a central facility having a database comprising data, said data comprising at least one library of uniquely identifiable information for authentic finished pharmaceutical dosage form corresponding to said sample, said database comprising data for finished pharmaceutical dosage forms manufactured by multiple manufacturers; and,
comparing said data for said sample to said data comprising at least one library.

43. The method of claim 42, wherein said finished pharmaceutical dosage form is selected from the group consisting of oral dosage forms, injectables, inhalants, intravenous solutions, transdermals, suppositories, ophthalmics, and combinations thereof.

44. The method of claim 42, further comprising the step of processing said data for said finished pharmaceutical dosage form.

45. The method of claim 42, wherein said at least one library is constructed from manufacturer-verified pharmaceutical material.

46. The method of claim 42, wherein the method further comprises the step of supplementing the library with the analytical data collected for the sample at said remote location.

47. The method of claim 42, the method further comprises the step of collecting assay data relating to said sample.

48. The method of claim 42, wherein said data comprising at least one library comprises data collected from forensic methods selected from the group consisting of near-infrared spectroscopy, infrared spectroscopy, UV-VIS spectroscopy, fluorescence spectroscopy, phosphorescence spectroscopy, Raman spectroscopy, microwave spectroscopy, photo-acoustic spectroscopy, X-ray spectroscopy, chemical imaging, and any combination thereof.

49. The method of claim 42, wherein said data comprising at least one library comprises data selected from the group consisting of images of products, packaging attributes, labeling attributes, product codes, lot number, expiration dates track and trace data, and any combination thereof.

50. The method of claim 42, wherein said at least one library is a validated library.

51. The method of claim 42, wherein said at least one library is an updated library.

52. The method of claim 42, wherein said database is a global database.

53. The method of claim 42, wherein said database is maintained and managed by an entity other than that performing the step of collecting.

54. A method for the determination of authenticity of a sample of pharmaceutical material comprising:
collecting data for said sample of pharmaceutical material at a remote location;
transmitting to said remote location from a database at a central facility, data comprising at least one library of uniquely identifiable information for authentic pharmaceutical material corresponding to said sample, said database comprising data for pharmaceutical material manufactured by multiple manufacturers; and,
comparing, at said remote location, said data for said sample of pharmaceutical material to said data comprising at least one library.

55. The method of claim 54, wherein said database is maintained and managed by an entity other than that performing the step of collecting.

56. A method for the determination of authenticity of a sample of finished pharmaceutical dosage form comprising:
collecting data for said sample of finished pharmaceutical dosage form at a remote location;
transmitting to said remote location from a database at a central facility, data comprising at least one library of uniquely identifiable information for authentic finished pharmaceutical dosage form corresponding to said sample, said database comprising data for finished pharmaceutical dosage forms manufactured by multiple manufacturers; and,
comparing, at said remote location, said data for said sample to said data comprising at least one library.

57. The method of claim 56, wherein said database is maintained and managed by an entity other than that performing the step of collecting.

58. A method for the determination of authenticity of a sample of a finished pharmaceutical dosage form comprising:
collecting data for said finished pharmaceutical dosage form at a remote location;
transmitting information to or receiving information from, a central facility having a database comprising data, said data comprising at least one library of uniquely identifiable information for authentic finished pharmaceutical dosage form corresponding to said sample; and,
comparing said data for said finished pharmaceutical dosage form to said data comprising at least one library.

59. A pharmaceutical authenticity verification system comprising:
a centrally maintained and managed database having data comprising at least one library of uniquely identifiable information for pharmaceutical material,
a remote instrument, said remote instrument collects data for a pharmaceutical sample and is in communication with said database.

60. The pharmaceutical authenticity verification system of claim 59, wherein said database is maintained and managed by an entity other than the entity that collects said data for a pharmaceutical sample.

61. A computer-implemented method of verifying authenticity of a pharmaceutical sample, said method comprising:
providing a centrally maintained and managed database comprising data of at least one library of uniquely identifiable information for authentic pharmaceutical material;
comparing data collected from a pharmaceutical sample; and,
determining whether the pharmaceutical sample is authentic.

62. A product comprising a computer program on a computer readable memory executable by a computer, said program comprising:
instructions for receiving data for a pharmaceutical material,
instructions for comparing said data for a pharmaceutical material to data in a centrally maintained and managed pharmaceutical information database, and
instructions for determining whether said pharmaceutical material is authentic or counterfeit.

63. A centrally maintained and managed information database system comprising:
data comprising at least one library of spectroscopic information for finished pharmaceutical dosage forms, said dosage forms being manufactured by multiple manufacturers;
a central facility to house said library and to transfer information from said central facility to at least one user; and,
a communication link between said central facility and said user.

64. The centrally maintained and managed information database system of claim 63 wherein at least one library of spectroscopic information comprises Near-IR data, Raman data, chemical imaging data, and any combination thereof.

65. The centrally maintained and managed information database system of claim 64 wherein said database is maintained and managed by an entity other than said user.

66. A method to identify a counterfeit sample of pharmaceutical material comprising:
collecting data for a sample of pharmaceutical material at a remote location;
transmitting information to or receiving information from, a central facility, said central facility having a database comprising at least one library of uniquely identifiable information for pharmaceutical material, said uniquely identifiable information comprising data for pharmaceutical material manufactured by multiple manufacturers; and,
comparing said data for said sample to said at least one library.

67. The method of claim 66 wherein said pharmaceutical material comprises a pharmaceutical ingredient selected from the group consisting of active pharmaceutical ingredients, excipients, pharmaceutical raw materials, pharmaceutical mixtures, pharmaceutical packaging materials, and any combination thereof.

68. The method of claim 66, wherein said pharmaceutical material is a finished pharmaceutical dosage form selected from the group of consisting of oral dosage forms, injectables, inhalants, intravenous solutions, transdermals, suppositories, ophthalmics, and any combination thereof.

69. The method claim 66, wherein said database comprising at least one library comprises data for counterfeit pharmaceutical material.

70. The method of claim 69, further comprising the step of correlating said data for said pharmaceutical sample to complimentary data for said sample.

71. The method of claim 66, further comprising the step of processing said data for said sample.

72. The method of claim 66, wherein said at least one library is constructed from manufacturer-verified pharmaceutical material.

73. The method of claim 66, wherein the method further comprises the step of supplementing the at least one library with data collected for the sample at said remote location.

74. The method of claim 66, wherein said remote location is a site selected from the group consisting of pharmaceutical manufacturers, drug distribution centers, drug repackaging facilities, ports-of-entry, customs facilities, import facilities, mail facilities, government centers, regulatory centers, pharmacies, hospitals, dispensaries, clinics, assisted-living facilities, and any combination thereof.

75. The method of claim 66, further comprising the step of collecting assay data for said sample of pharmaceutical material.

76. The method of claim 66, wherein said database comprising at least one library comprises data collected from forensic methods selected from the group consisting of near-infrared spectroscopy, infrared spectroscopy, UV-VIS spectroscopy, fluorescence spectroscopy, phosphorescence spectroscopy, Raman spectroscopy, microwave spectroscopy, photo-acoustic spectroscopy, X-ray spectroscopy, chemical imaging, and any combination thereof.

77. The method of claim 66, wherein said database comprising at least one library comprises data selected from the group consisting of images of products, packaging attributes, labeling attributes, product codes, lot number, expiration dates track and trace data, and any combination thereof.

78. The method of claim 66, wherein said at least one library is a validated library.

79. The method of claim 66, wherein said at least one library is an updated library.

80. The method of claim 66, wherein said database is a global database.

81. The method of claim 66, wherein said database comprising at least one library comprises a plurality of libraries.

82. The method of claim 66, wherein said database is maintained and managed by an entity other than that performing the step of collecting data.

83. A method to detect a medication error comprising:
collecting data for a sample of finished pharmaceutical dosage form at a remote location;
transmitting information to or receiving information from, a central facility, said central facility having a database comprising at least one library of uniquely identifiable information comprising data for finished pharmaceutical dosage forms, and,
comparing said data for said sample to said at least one library.

84. The method of claim 83, wherein said finished pharmaceutical dosage form is selected from the group consisting of oral dosage forms, injectables, inhalants, intravenous solutions, transdermals, suppositories, ophthalmics, and any combination thereof.

85. The method claim 83, wherein said at least one library of uniquely identifiable information comprises data for counterfeit finished pharmaceutical dosage forms.

86. The method of claim 85, further comprising the step of correlating said data for said pharmaceutical sample to complimentary data for said sample.

87. The method of claim 83, further comprising the step of processing said data for said finished pharmaceutical dosage form.

88. The method of claim 83, wherein said at least one library is constructed from manufacturer-verified pharmaceutical material.

89. The method of claim 83, wherein the method further comprises the step of supplementing the library with the analytical data collected for the sample at said remote location.

90. The method of claim 83, wherein said remote location is a site selected from the group consisting of pharmacies, hospitals, dispensaries, clinics, assisted-living facilities, and any combination thereof.

91. The method of claim 83, the method further comprises the step of collecting assay data for said sample of finished pharmaceutical dosage form.

92. The method of claim 83, wherein said at least one library comprises data collected from forensic methods selected from the group consisting of near-infrared spectroscopy, infrared spectroscopy, UV-VIS spectroscopy, fluorescence spectroscopy, phosphorescence spectroscopy, Raman spectroscopy, microwave spectroscopy, photo-acoustic spectroscopy, X-ray spectroscopy, chemical imaging, and any combination thereof.

93. The method of claim 83, wherein said at least one library comprises data selected from the group consisting of images of products, packaging attributes, labeling attributes, product codes, lot number, expiration dates, track and trace data and any combination thereof.

94. The method of claim 83, wherein said at least one library is a validated library.

95. The method of claim 83, wherein said at least one library is an updated library.

96. The method of claim 83, wherein the database is a global database.

97. The method of claim 83, wherein said at database comprising at least one library comprises a plurality of libraries.

98. The method of claim 83, wherein said database is maintained and managed by an entity other than that performing the step of collecting data.
